(19) United States
(12) Patent Application Publication
(10) Pub. No.: US 2008/0028535 A1
(43) Pub. Date: Feb. 7, 2008

(54) Articulated Mattress

(76) Inventor: Victor Manuel Rodrigues Moreira, Trofa Santiago do Bougado (PT)

Correspondence Address: WENDEROTH, LIND & PONACK, L.L.P., 2033 K STREET N. W., SUITE 800, WASHINGTON, DC, 20006-1021, US

(21) Appl. No.: 11/587,768

(22) PCT Filed: Sep. 20, 2004
(86) PCT No.: PCT/IB04/03191

§ 371 Date: Jan. 25, 2007

(30) Foreign Application Priority Data
May 28, 2004 (PT) 103128

(51) Int. Cl. A47C 27/00; A61G 7/015

(52) U.S. Cl. 5/722; 5/933; 5/618

(57) ABSTRACT

The present invention refers to an articulated mattress that does not need any specific frame for its perfect functioning, mattress that may be provided with a massage device, being destined to the general market, having particular application in the field of health and prevention and being included in the group of products that provide comfort and wellbeing. The said mattress (1) is characterised in that it is articulated, in that it is provided with an internal support structure (2) of the plate (3) and of the cushion (4) and with an external stabilisation structure (5), that one comprised by a superior element (6), by an inferior element (7) and by a central element (8), this one (8) being connected to the other two elements by means of joints (12) and having at least two supports (15) for pivoted fixation of the elevation mechanisms (9) responsible for the movement, independently, of the superior element (6) and of the inferior element (7), the internal structure (2) being, in turn, connected to the external structure (5) by means of, at least, a foot (10) with which is provided the central element (8), connection that is of the removable type.

### TECHNICAL DOMAIN

This invention relates to an articulated mattress that does not need any specific frame for its perfect functioning, mattress that may be, or not, provided with a massage device.

The mattress invented is destined, in general, to the market as a whole, without restrictions, being included in the group of products that provide comfort and wellbeing, having particular application in the area of health and prevention, and may be used advantageously in the case of bed-ridden people or in convalescence, or for purposes of therapeutic and/or orthopaedic treatments and, therefore, it is destined, in particular, given the advantages that it presents when compared to the known solutions, to equip hospitals, retirement homes and care centres, among others.

### STATE OF THE ART

Are known several devices of articulated beds of mechanical or electric operation, being still common the use of beds with a mechanical system of operation, by lever, of the bed frame, namely in hospitals.

Are also known several articulated frames, more modern, electrically operated, the mattresses that lay on such frames folding accordingly to the movement of those frames.

However, there is no knowledge of any articulated mattress and, consequently, even less of articulated mattress with the innovating technical characteristics that this invention presents, which are described below in detail, characteristics that provide it with a set of noteworthy advantages when compared with the known devices.

Right away, the great easiness of use allied to the safety, since there is no risk of getting a finger or a hand trapped when the mattress is operated, for example through an electric control, risk that is present in the case of the articulated frames.

It is known that, in what concerns the bed-ridden people, are indispensable the cares with the body, namely with the blood flow, bearing in mind the great immobility of these people's condition, under penalty of that state of immobility motivating, for example, chronic wounds.

Well, the present invention does not only provide physical wellbeing particularly to these people, acting on the patient's systems of blood and lymphatic flow, but it also provides psychological wellbeing—by rule of great importance in the recovery of the patients—since for the patient to be able to take advantage of that double wellbeing, it is enough to have the mattress of his bed replaced for the one that is object of the present invention, without need to replace the bed, not changing the surroundings of the patient.

It should also be noted that the internal and external structure of the mattress, that characterise it, do not limit its shape, which may be the traditional, that is, rectangular, or other less conventional, as for example the circular, the oval, heart shaped, or other, either it is a single person mattress or a mattress for couple.

### DESCRIPTION OF THE INVENTION

The present invention refers to an articulated mattress provided with an internal structure of support of the plate and of the cushion and with and external structure of stabilisation, that one composed by a superior element, by a inferior element and by a central element, the other two elements being connected to this one by means of joints.

The central element is provided with, at least, two supports for pivoting fixation of the elevation mechanisms responsible for the movement, independently, of the superior element and of the inferior element.

The internal structure is, in turn, connected to the external structure by means of, at least, a foot with which the central element is provided, connection that is of the removable type.

The central element may be tubular and comprised by two rails, having joints at the extremities, and by two crossheads, connected, by the extremities, to those rails, the crossheads being provided with a reinforcement that unites them, thus being created a firm and fixed set.

Each crosshead is provided, at least, with a support for pivoting fixation of an elevation mechanism and each one of them may have two feet.

The connection of the central element to the superior element is made by means of joints that the rails have at the extremities.

The superior element comprises, besides a peripheral portion which may be tubular, a tilted longitudinal lever, integral with said portion and provided, at the extremity nearer the central element, with a pivoting connection to the telescopic arm of the elevation mechanism of the superior element, the extremity of the lever with pivoting connection is always closer to the ground than the other extremity, regardless of the position of the superior element.

The peripheral portion of the superior element of the internal structure may be reinforced by one crosshead, or more than one crosshead, whenever that is convenient, as in the case of a couple's mattress.

It may, additionally, be reinforced by a longitudinal element.

That portion, the longitudinal element and the crosshead are positioned in a common plane and are solidly connected among themselves, the crosshead being situated near the extremities of the said portion.

Moreover, the mentioned longitudinal element and the lever of the superior element may be connected by means of a connection piece—that is connected to the lever before its extremity by pivoting connection—forming a rigid triangle.

On the other hand, the inferior element of the internal structure may be equally tubular, comprised by a peripheral portion, continuous or interrupted by joints.

The extremities of that peripheral portion have connection with the central element at the joints that the rails have at the extremities.

The inferior element comprises, at least, a tilted longitudinal lever integral, directly, with the mentioned peripheral portion, or indirectly, resorting, in this case, to a crosshead or to a similar element, provided, at the extremity closer to the central element, with a pivoting connection to the telescopic arm of the elevation mechanism of the inferior element or of a part of this element.

As was stated above, the peripheral portion of the inferior element may be subdivided in several parts, particularly in two, being, in this case, the extreme part provided with joints with stop that allow the connection with the adjacent interior part.

This interior part is provided with a tilted longitudinal lever, integral with the peripheral portion of this part and provided, at the extremity closer to the central element, with a pivoting connection to the telescopic arm of the elevation mechanism of the inferior element, the extremity of the lever with pivoting connection being always closer to the ground than the other extremity, regardless of the position of the inferior element.

Still in the case the peripheral portion of the inferior element is subdivided in two parts, the extreme part may have a crosshead situated next to the joints with stop and the interior part may have, also next to those joints, a crosshead and another crosshead situated next to the joints that connect it to the central element, these two last crossheads being braced by a longitudinal element.

On the other hand, the peripheral portion of the interior part, those two crossheads and the longitudinal element must be positioned on a common plane and connect one another solidly.

Furthermore, that longitudinal element, the lever mentioned above and a connection piece between these two—that is connected to the lever before its extremity with pivoting connection—form a rigid triangle.

Bearing in mind the described before, it is understood that one could easily subdivide in three parts the peripheral portion of the inferior element of the articulated mattress.

Besides the already mentioned advantages, the mattress invented is robust and resistant and is provided with elevation mechanisms of smooth and silent operation and of easy maintenance.

With this invention is also facilitated the task of making the bed traditionally, that is, by folding the sheets and/or bed covers underneath the mattress, since it will not be necessary to lift up the mattress.

### DESCRIPTION OF THE FIGURES

In the enclosed figures, presented as non limitative examples, may be observed:

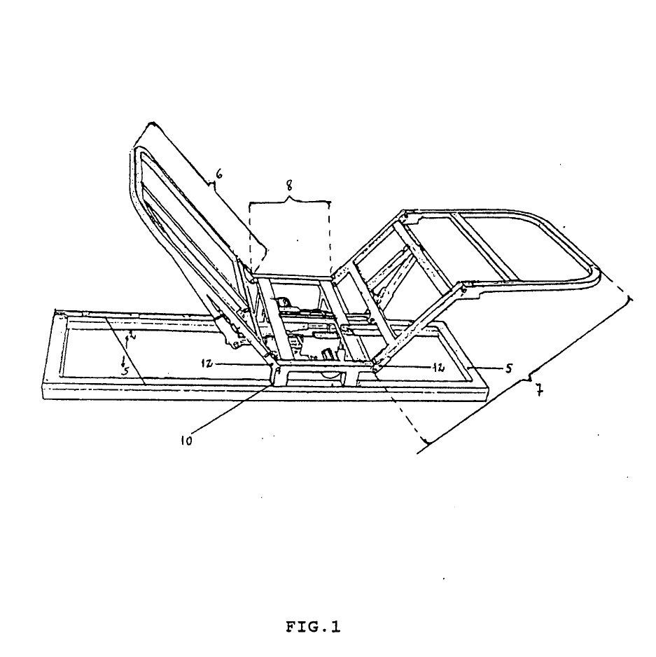

in FIG. 1, the representation, in perspective, of the upper side of the internal (of support) and external (of stabilisation) structures of the articulated mattress of the invention—these connected by means of four feet—both the superior element and the inferior element being in lifted position;

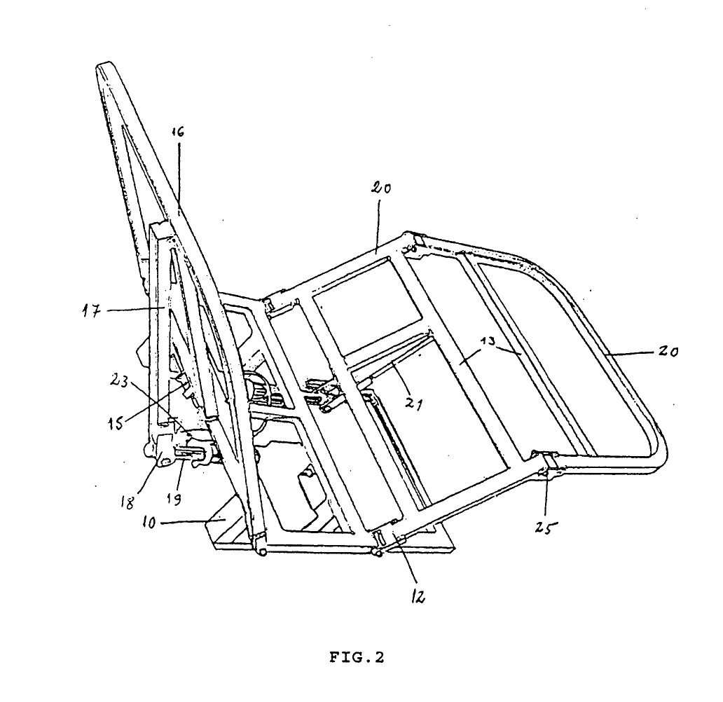

in FIG. 2, the representation, in perspective, of the upper side of the internal support structure of the articulated mattress of the invention, being in lifted position both the superior element and the inferior element, this one comprised by two parts;

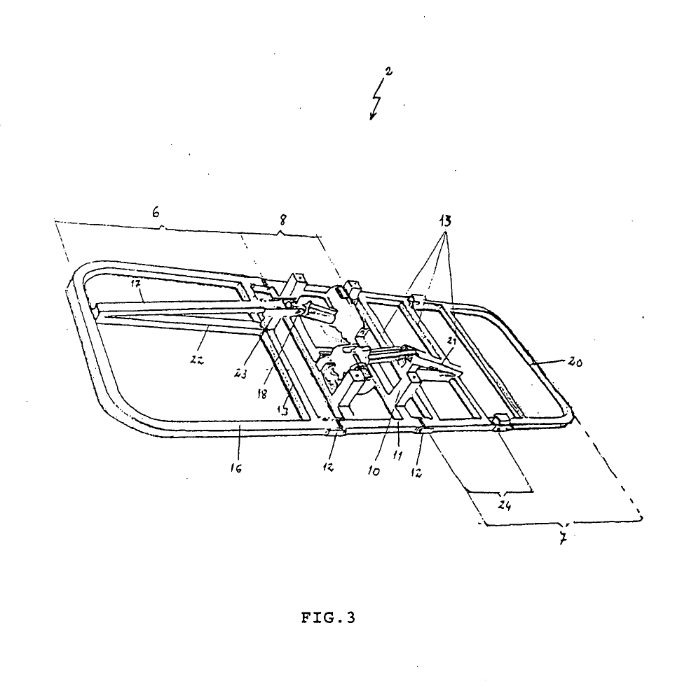

in FIG. 3, the representation, in perspective, of the down side of the internal support structure of the articulated mattress of the invention, in horizontal position;

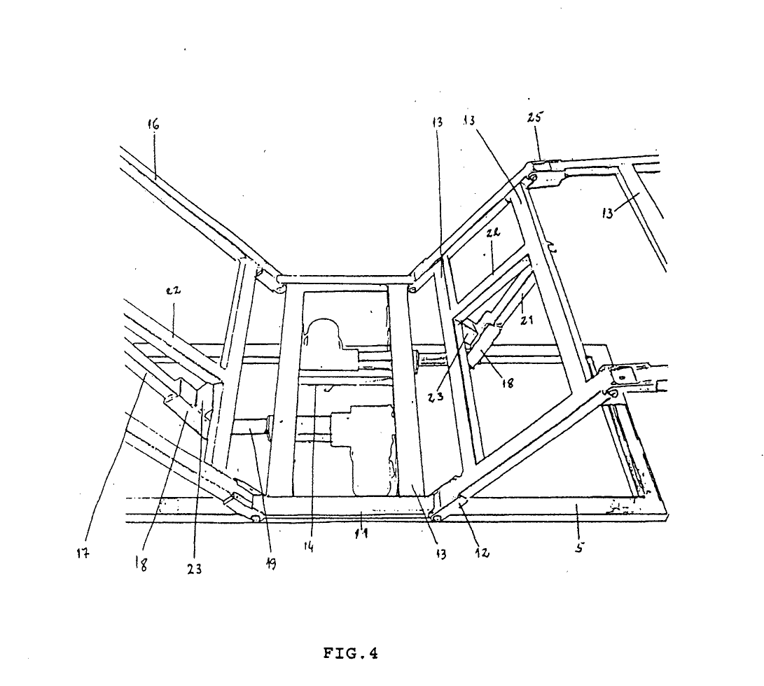

in FIG. 4, the representation, in perspective, of the upper side of the internal (of support) and external (of stabilisation) structures of the articulated mattress of the invention, showing them not complete;

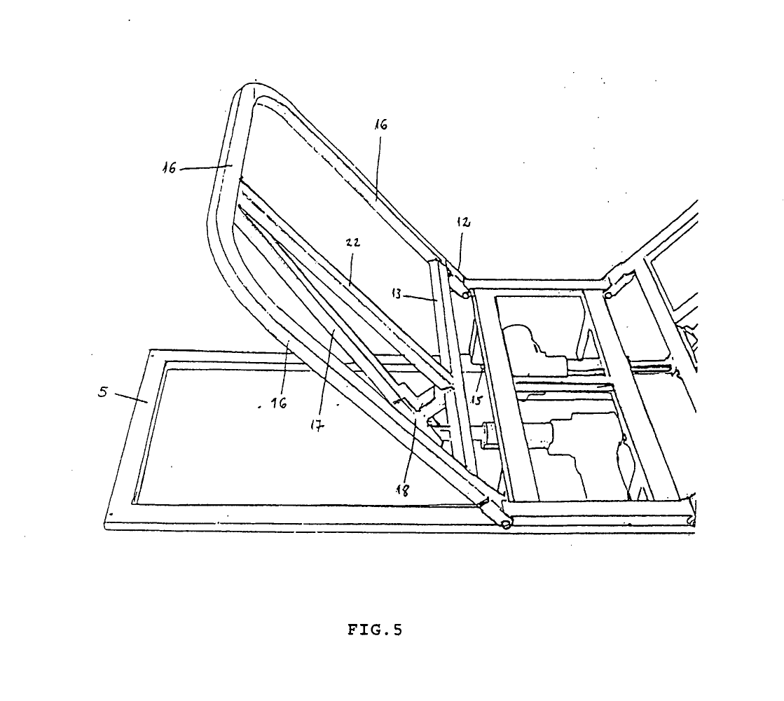

in FIG. 5, the representation, in perspective, of the upper side of the internal (of support) and external (of stabilisation) structures of the articulated mattress of the invention, showing, in particular, the superior and central elements of the internal structure;

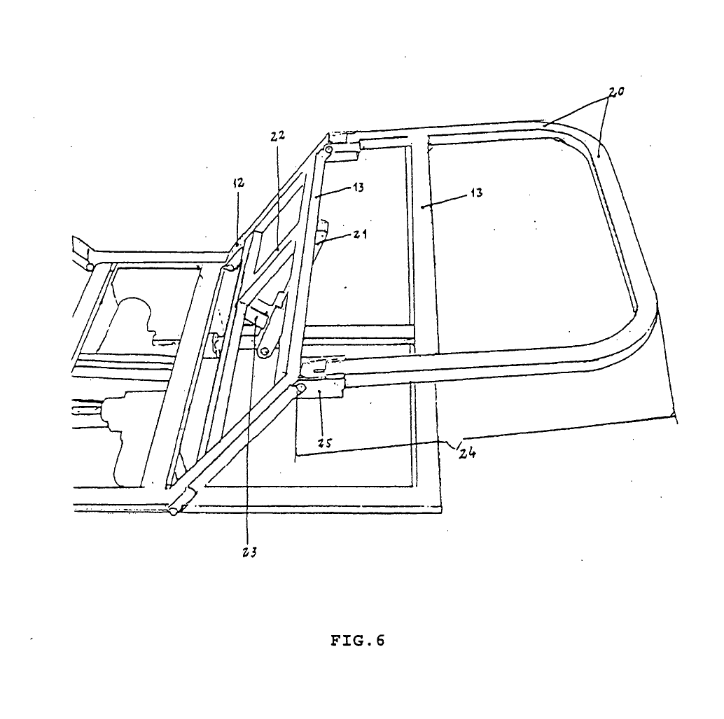

in FIG. 6, the representation, in perspective, of the upper side of the internal (of support) and external (of stabilisation) structures of the articulated mattress of the invention, showing, in particular, the inferior element of the internal structure comprised by two parts;

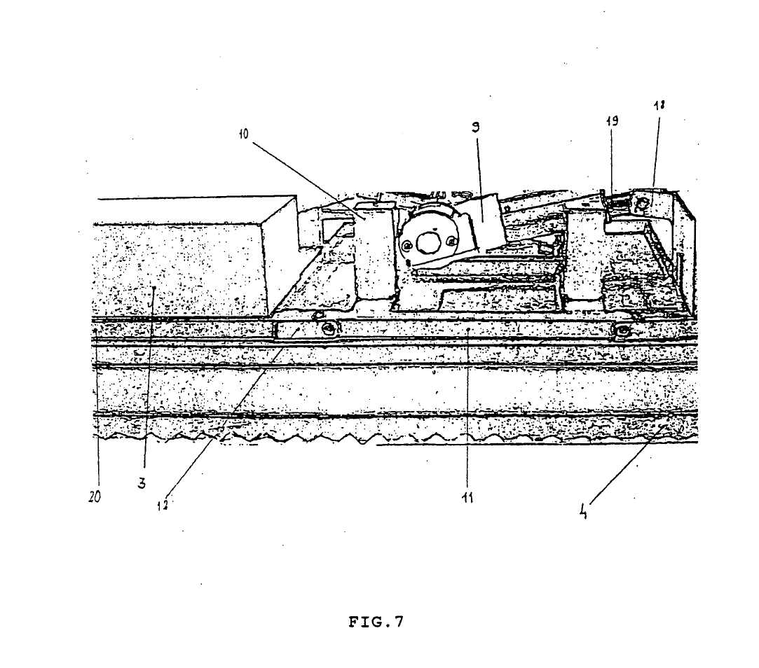

in FIG. 7, the representation, in perspective, of the down side of the internal support structure of the plate and of the cushion of the articulated mattress of the invention, showing, in particular, the set formed by that structure and by those elements of stuffing, plate and cushion, at the zone of the central element.

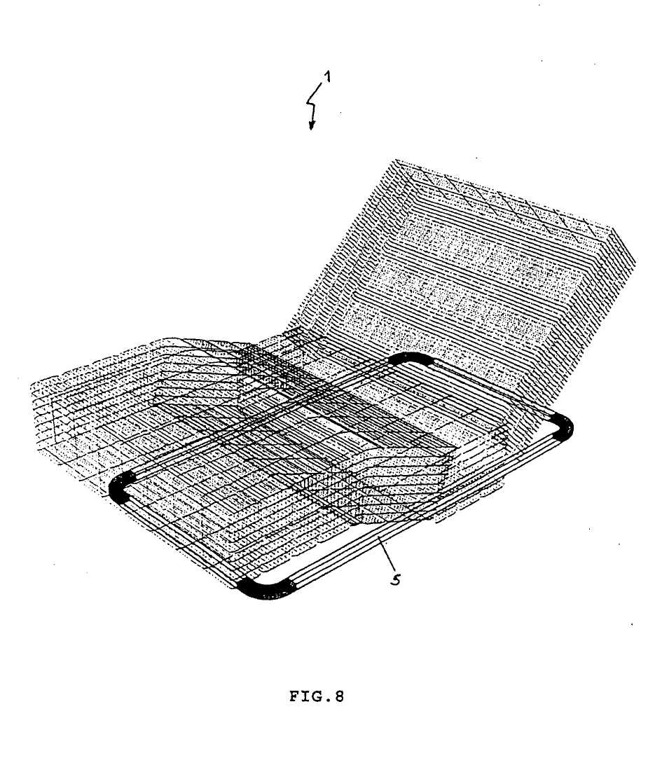

in FIG. 8, the representation, in perspective, of the articulated mattress of the invention integrating an external stabilisation structure and an internal support structure—this one not visible in the figure—whose inferior element is comprised by two parts, being in a lifted position, both this element and the superior element.

In particular the mentioned figures show:
1—Articulated mattress
2—Internal support structure
3—Plate
4—Cushion
5—External stabilisation structure
6—Superior element
7—Inferior element
8—Central element
9—Elevation mechanism
10—Foot
11—Rail
12—Joint
13—Crosshead
14—Reinforcement
15—Support for elevation mechanism
16—Peripheral portion of the superior element
17—Lever integral with the superior element
18—Pivoting connection
19—Telescopic arm
20—Peripheral portion of the inferior element
21—Lever integral with the inferior element
22—Longitudinal element
23—Connection piece
24—Part
25—Joint with stop

### PARTICULAR EMBODIMENT OF THE INVENTION

As was mentioned before, the articulated mattress of the invention may incorporate a massage device, being possible, for that effect, to resort to a cushion with notched profile (4) provided with multiple protuberances and concavities, those providing a massage of the digital type and serving these to house magnets that provide the creation of a magnetic field.

The plate (3) may be produced in latex, in stylatex or in another appropriate material.

In turn, the structure, either internal (2), or external (5), will be made, preferably, in iron, in aluminium or in plastic material, or combining such materials.

Furthermore, the internal structure (2) may be laminar ribbed and the external structure (5) must be flat, continuous—or discontinuous in the zone of the head and/or feet of the mattress—tubular or in bar, being circumscribed by the vertical projection of the exterior outline of the mattress and at a small distance of that outline.

On the other hand, the connection of the foot or feet (10) of the central element (8) to the external stabilisation structure (5) may be made by means of screws, plugs or fast fitting.

The plate (3) and the cushion (4), as well as their internal support structure (2) and the elevation mechanisms (9) are involved by a lining, preferably removable, with small openings at the zone of the feet (10).

The elevation mechanisms (9) must be operated through a device comprising a transformer and batteries—in case of electrical supply shortage the articulated mattress returns to the horizontal position—be fed by electric power of 24 V and have limiter switches and a safety fuse.

The elevation (9) and massage mechanisms and other integrated equipment, such as, for example, sound equipment, may be operated by means of a single remote control.

1. Mattress (1) with or without massage, characterised in that it is articulated, in that it is provided with an internal support structure (2) of the plate (3) and of the cushion (4) and with an external stabilisation structure (5), that one comprised by a superior element (6), by an inferior element (7) and by a central element (8), the two other elements being connected to this one (8) by means of joints (12), the central element having at least two supports (15) for pivoting fixation of the elevation mechanisms (9) responsible for the movement, independently, of the superior element (6) and of the inferior element (7), and, in turn, the internal structure (2) being connected to the external structure (5) by means of, at least, one foot (10) with which the central element (8) is provided, connection that is of the removable type.

2. Mattress according to claim no. 1, characterised in that the central element (8) is fix, tubular and constituted by two rails (11), having joints (12) at the extremities, and by two crossheads (13) connected, by the extremities, to those rails (11), the crossheads (13) being provided with a reinforcement (14) that units them, in that each crosshead (13) has two feet (10) and in that each one of them is provided with, at least, a support (15) for pivoting fixation of an elevation mechanism (9).

3. Mattress according to claim no. 2, characterised in that the central element (8) has symmetry regarding a plane perpendicular to the rails (11) having the same distance to each crosshead (13).

4. Mattress according to claim no. 1, characterised in that the superior element (6) of the internal structure (2) is comprised by a tubular peripheral portion (16), whose extremities connect with the central element (8) of that structure at the joints (12) with which the rails (11) are provided at the extremities and by a tilted longitudinal lever (17), integral with that peripheral portion (16) and provided with, at the extremity nearer the central element (8), a pivoted connection (18) to the telescopic arm (19) of the elevation mechanism (9) of the superior element, the extremity of the lever with the pivoted connection (18) being always closer to the ground than the other extremity, whatever the position of the superior element (6).

5. Mattress according to claim no. 4, characterised in that the peripheral portion of the superior element (16) of the internal structure (2) is reinforced by a crosshead (13) or by a similar element and by a longitudinal element (22), the portion (16), the crosshead (13) and the longitudinal element (22) being positioned in a common plane and being solidly interconnected, that crosshead (13) situated next to the extremities of the said portion (16) and in that the lever (17), the longitudinal element (22) and a connection piece (23) between these two—that is connected to the lever before its extremity with pivoted connection—form a rigid triangle.

6. Mattress according to claim no. 5, characterised in that the peripheral portion of the superior element (16) of the internal structure (2) is reinforced by at least two crossheads (13) in case it is a couple's mattress.

7. Mattress according to claim no. 1, characterised in that the inferior element (7) of the internal structure (2) is tubular, comprised by a peripheral portion (20)—continuous or interrupted by joints (12)—whose extremities connect with the central element (8) of that structure at the joints (12) that the rails (11) have at the extremities and by, at least, a tilted longitudinal lever (21) integral, directly, with that peripheral portion (20), or indirectly, resorting, in this case, to a crosshead (13) or to a similar element, provided with, at the extremity nearer the central element, a pivoted connection (18) to the telescopic arm (19) of the elevation mechanism (9) of the inferior element or of a part (24) of this element.

8. Mattress according to claim no. 7, characterised in that the peripheral portion of the inferior element (20) is subdivided in two parts (24), the extreme part being provided with joints with stop (25) that allow the connection with the adjacent interior part, this interior part having a tilted longitudinal lever (21), integral with the peripheral portion of the said part, and provided, at the extremity closer to the central element (8), with a pivoted connection (18) to the telescopic arm (19) of the elevation mechanism (9) of the inferior element, the extremity of the lever provided with the pivoted connection (18) being always closer to the ground than the other extremity, whatever the position of the inferior element (7).

9. Mattress according to claim no. 8, characterised in that the extreme part has a crosshead (13) situated next to the joints with stop (25), in that the interior part has, also next to those joints (25), a crosshead (13) and another crosshead (13) situated next to the joints (12) that connect it to the central element (8), these two last crossheads being braced by a longitudinal element (22), the peripheral portion of this part, those two crossheads (13) and the longitudinal element (22) being positioned in a common plane and connecting to each other solidly and in that the lever (21), the longitudinal element (22) and a connection piece (23) between these two—that is connected to the lever before its extremity with pivoted connection—form a rigid triangle.

10. Mattress according to claim no. 7, characterised in that the peripheral portion of the inferior element (20) is subdivided in three parts (24), the part closer to the central element (8) having, at least, a crosshead (13) or a similar element, having a support (15) for pivoted fixation of elevation mechanism (9) and the intermediate part having also, at least, a crosshead (13) or a similar element to which is integral a lever.

11. Mattress according to claim no. 1, characterised in that the internal support structure (2) is laminar ribbed.

12. Mattress according to claim no. 1, characterised in that the connection of the foot or feet (10) of the central element (8) to the external stabilisation structure (5) is made by means of screws, plugs or fast fitting.

13. Mattress according to claim no. 1, characterised in that the external stabilisation structure (5) is flat, continuous—or discontinuous at the zone of the head and/or feet of the mattress—tubular or in bar and in that it is circumscribed by the vertical projection of the outer outline of the mattress and at a small distance of that outline.

14. Mattress according to claim no. 1, characterised in that the elevation mechanisms (9) are operated through a device comprising a transformer and batteries and in that said mechanisms have limiter switches.

15. Mattress according to claim no. 1, characterised in that the elevation mechanisms (9) are fed by continuous electrical power of 24 V and have a safety fuse.

16. Mattress according to claim no. 2, characterised in that the superior element (6) of the internal structure (2) is comprised by a tubular peripheral portion (16), whose extremities connect with the central element (8) of that structure at the joints (12) with which the rails (11) are provided at the extremities and by a tilted longitudinal lever (17), integral with that peripheral portion (16) and provided with, at the extremity nearer the central element (8), a pivoted connection (18) to the telescopic arm (19) of the elevation mechanism (9) of the superior element, the extremity of the lever with the pivoted connection (18) being always closer to the ground than the other extremity, whatever the position of the superior element (6).

17. Mattress according to claim no. 16, characterised in that the peripheral portion of the superior element (16) of the internal structure (2) is reinforced by a crosshead (13) or by a similar element and by a longitudinal element (22), the portion (16), the crosshead (13) and the longitudinal element (22) being positioned in a common plane and being solidly interconnected, that crosshead (13) situated next to the extremities of the said portion (16) and in that the lever (17), the longitudinal element (22) and a connection piece (23) between these two—that is connected to the lever before its extremity with pivoted connection—form a rigid triangle.

18. Mattress according to claim no. 17, characterised in that the peripheral portion of the superior element (16) of the internal structure (2) is reinforced by at least two crossheads (13) in case it is a couple's mattress.

19. Mattress according to claim no. 2, characterised in that the inferior element (7) of the internal structure (2) is tubular, comprised by a peripheral portion (20)—continuous or interrupted by joints (12)—whose extremities connect with the central element (8) of that structure at the joints (12) that the rails (11) have at the extremities and by, at least, a tilted longitudinal lever (21) integral, directly, with that peripheral portion (20), or indirectly, resorting, in this case, to a crosshead (13) or to a similar element, provided with, at the extremity nearer the central element, a pivoted connection (18) to the telescopic arm (19) of the elevation mechanism (9) of the inferior element or of a part (24) of this element.

20. Mattress according to claim no. 19, characterised in that the peripheral portion of the inferior element (20) is subdivided in two parts (24), the extreme part being provided with joints with stop (25) that allow the connection with the adjacent interior part, this interior part having a tilted longitudinal lever (21), integral with the peripheral portion of the said part, and provided, at the extremity closer to the central element (8), with a pivoted connection (18) to the telescopic arm (19) of the elevation mechanism (9) of the inferior element, the extremity of the lever provided with the pivoted connection (18) being always closer to the ground than the other extremity, whatever the position of the inferior element (7).
